(19) United States
(12) Patent Application Publication
(10) Pub. No.: US 2005/0068987 A1
(43) Pub. Date: Mar. 31, 2005

(54) Highly configurable radar module link

(76) Inventors: Carl van Schaik, Chatswood (AU); Alan Langman, Milnerton (ZA)

Correspondence Address: Mark E. Fejer;Gas Technology Institute, 1700 South Mount Prospect Road, Des Plaines, IL, 60018, US

(21) Appl. No.: 10/919,891

(22) Filed: Aug. 17, 2004

Related U.S. Application Data
(60) Provisional application No. 60/505,541, filed on Sep. 24, 2003.

(51) Int. Cl. H04J 3/06

(52) U.S. Cl. 370/503

(57) ABSTRACT

A communications apparatus having a bidirectional, fair multiple-access, synchronous serial communications protocol operational with a single clock and a single data signal, which single clock is adapted to provide a uni-directional clock signal to synchronize a remote end of the apparatus with the single clock.

### CROSS-REFERENCE TO RELATED APPLICATION

This application claims the benefit of provisional U.S. patent application Ser. No. 60/505,541 having a filing date of 24 Sep. 2003.

### BACKGROUND OF THE INVENTION

1. Field of the Invention

This invention relates to digital serial data communication protocols.

2. Description of Related Art

Most serial communications protocols fall into two categories, synchronous and asynchronous. Synchronous communication involves the transmission of data relative to a clock to which both transmitter and receiver are synchronized. Asynchronous communications involves transmitting and receiving data with different clocks, which in practice must be close, but not exactly the same in frequency.

All synchronous communications protocols require that a reference clock be provided with the data. Most of these protocols for serial communications transmit a clock with the data, either as a discrete clock signal, or as an encoded clock/data signal. Synchronous protocols that transmit separate clock and data signals require that there be at least one clock and data signal in each transmission direction. Protocols that employ data/clock encoding on a single signal require clock/data extraction at the receiver.

Field Programmable Gate Array (FPGA) devices are common electronic devices used for the implementation of arbitrary digital logic circuits. This makes them suitable for low cost digital and custom digital communications designs. However, most FPGA devices presently available do not have the technology to decode high speed clock/data encoded communications without external components.

For certain applications, it is necessary to have a system comprised of multiple nodes that is distributed and clock synchronous, with minimal inter-node wiring. What is required is to implement this distributed system with a high speed communications link between nodes where each node can be comprised of a single FPGA device without further external components. It is required that the system contains a single clock and a single data signal between nodes and is capable of bidirectional communications. No presently available serial communications protocols have been identified as meeting these requirements.

Conventional serial communication protocols provide a stream or packet based system that requires further logic in order to implement useful communications. Very few protocols provide a means to create a transparent link that requires no external logic for communication. Specifically, a means to provide a serial bridge between two parallel busses with support for multiple masters on both sides of the link is required.

### SUMMARY OF THE INVENTION

It is one object of this invention to provide a communications apparatus comprised of multiple nodes that is distributed and clock synchronous, with minimal inter-node wiring.

It is another object of this invention to provide a protocol for a communications apparatus which provides a transparent link that requires no external logic for communication.

It is yet another object of this invention to provide a communications apparatus comprising a distributed system with a high speed communications link between nodes where each node can be comprised of a single FPGA device without further external components.

These and other objects of this invention are addressed by a communications apparatus comprising a bidirectional, fair multiple-access, synchronous serial communications protocol operational with a single clock and a single data signal, with the single clock being adapted to provide a unidirectional clock signal to synchronize a remote end of the apparatus with the single clock. As used herein, the term “fair” as used in describing multiple-access communications essentially means non-discriminatory multiple access communications.

This protocol differs from other existing communications protocols in several fundamental aspects. In contrast to conventional communications protocols, in the protocol employed in this invention, a single uni-directional clock signal is employed to synchronize the remote end with the clock source. All data is transmitted over a single data signal in synch with the clock signal with the data signal providing two bits of information per clock period (Double Data Rate or DDR). The protocol uses a synchronous, command based protocol with implicit data acknowledgement, automatic error detection and retry, link connection monitoring and interrupt transport support.

The protocol, referred to herein as a Radar Module Link (RML), is divided into six logical layers of which layers one to five are required for compliance and layer six is provided as one possible implementation. The lowest layer (layer one), named the Physical Layer, describes the physical and mechanical requirements for the protocol. Layer two describes the electrical signal requirements for the protocol, including signal types, levels and timing requirements. Alternate layer one and layer two specifications may be designed for use on different electrical media. Layer three defines the Character Layer. Short four and ten bit consecutive bit sequences are defined as characters. Two character types are defined. Command types are four bits and Information types are ten bits long. Layer four defines the Exchange layer, which describes the states and state transitions (state machine) of the RML protocol. This includes the link initialization sequence, run state, error handling, and restart sequence. Layer five defines the packet layer, which describes how information is transferred and how fair multiple-access of bus access is maintained. Layer six defines a network layer which describes how multiple nodes can be linked with multiple Radar Module Links to create a synchronous network of nodes.

The RML protocol of this invention provides a virtual parallel-bus link between two nodes with support for multiple bus master devices on either node. Each bus master is able to access any slave device on either side of the link simply by addressing the slave with its unique address. No further action is required from the bus master if the addressed slave is located on a different node. The RML controller, in accordance with the defined layer six protocol, automatically forwards the request across one or multiple RMLs to the addressed slave device. The RML master has no knowledge of this other than inspecting the slave address.

### BRIEF DESCRIPTION OF THE DRAWINGS

These and other objects and features of this invention will be better understood from the following detailed description taken in conjunction with the drawings wherein:

FIGS. 1-4 show the elements of the Physical Layer of the RML protocol in accordance with one embodiment of this invention;

FIGS. 5-8 show the elements of the Character Layer of the RML protocol in accordance with one embodiment of this invention;

FIGS. 9-14 show the elements of the Exchange Layer of the RML protocol in accordance with one embodiment of this invention;

FIG. 15 shows the global addressing scheme for the RML protocol in accordance with one embodiment of this invention; and

FIG. 16 shows the structure of an RML network in accordance with one embodiment of this invention.

### DETAILED DESCRIPTION OF THE PRESENTLY PREFERRED EMBODIMENTS

The invention is described herein in the context of one specific implementation, which is RML, and there is no intention that this invention be limited to the embodiments set forth herein.

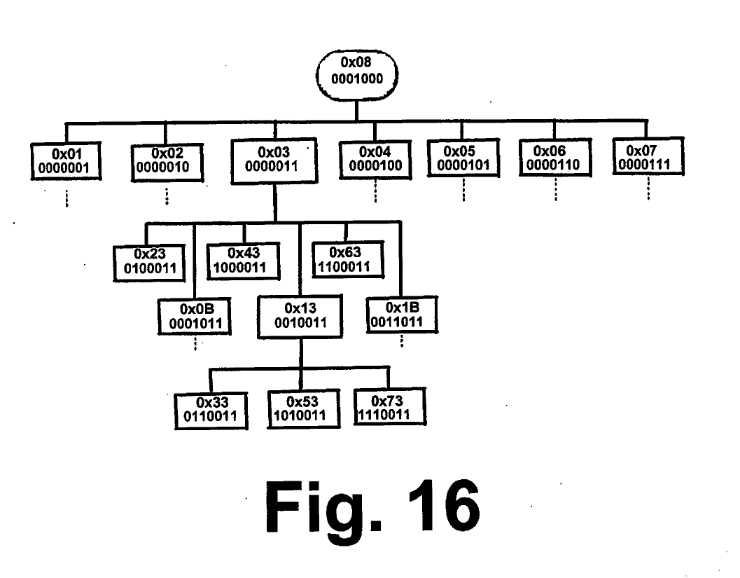

The RML standard in accordance with this invention specifies a method for bridging a parallel bus to a remote node over a serial communications channel. It implements a bi-directional, point-to-point, master-slave, parallel-to-serial data-bus link. It uses two pairs of differential channels (4 wires) for minimal cabling requirements and all communications are synchronous with the RML master-generated clock. The structure of an RML network in accordance with one embodiment of this invention and discussed in further detail herein below is shown in FIG. 16.

An RML network in accordance with one embodiment of this invention comprises a single node that controls the address space and configuration. Each RML also has a master-slave structure which has no relation to the RML network configuration. An RML master interface transmits the RML clock and initiates communication on the link. An RML slave interface receives and operates synchronously with this clock. Apart from these differences, RML master and slave interfaces operate identically. This allows any node in the system to be the clock synchronization source. In addition, a node may implement a clock domain crossing interface linking two or more separately clocked networks.

An RML in accordance with one embodiment of this invention provides two interfaces, an external serial interface to connect to another RML node in a master-slave clock configuration and a transparent bus bridge linked to a System on Chip (SOC) bus within a device. This transparent interface will automatically accept bus transactions that are addressed to a node that it determines to be accessible across the link. The RML interface will forward the bus request using the RML protocol across the link where the RML interface on the receiving side will issue the forwarded request on that node's SOC bus. Multiple links can be spanned by two RML interfaces communicating via the SOC bus. This happens transparently to the RML interface initiating a transaction on the SOC bus.

As previously stated, the RML protocol of this invention comprises six levels or layers: the Physical Layer, the Signal Layer, the Character Layer, the Exchange Layer, the Packet Layer, and the Network Layer. Each of these layers is described in detail herein below.

Physical Layer

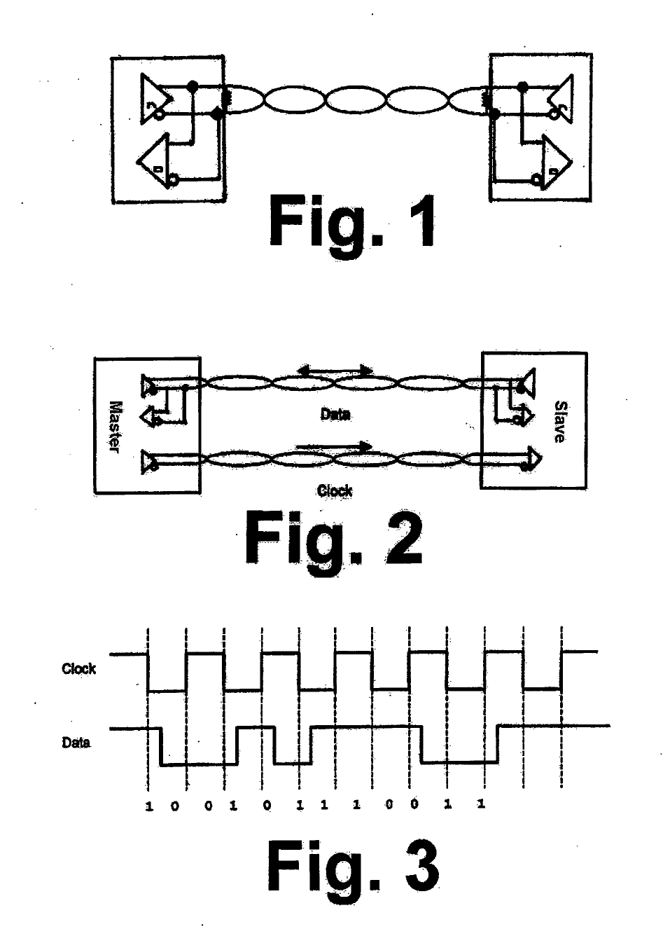

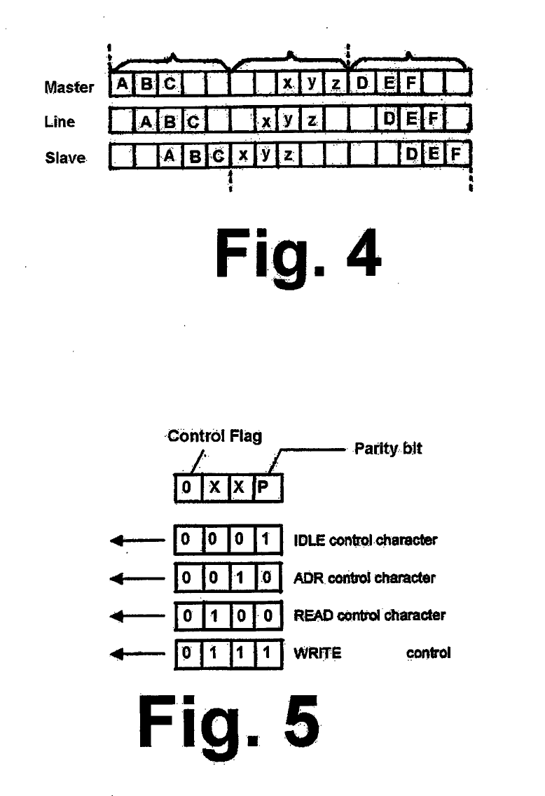

The physical layer details the physical connectors, cabling, termination and PCB tracks (FIGS. 1-4). The RML of this invention is designed for low EMI emissions and high noise immunity.

Connectors

The RML protocol specifies no formal connector requirements other than the requirement for the connector to introduce no excess EMI emissions or impedance discontinuities on the link. In addition, the connectors must have at least five contacts, four for differential signals and a ground signal connected to the cable shield.

Cabling

The RMLs can operate over any cable having at least two differential signal pairs and one screen. Individual screening of pairs is recommended for data rates higher than 50 Mbit/s. It is the responsibility of the system designer to choose cabling that meets the system electromagnetic interference (EMI) and noise rejection requirements. When choosing suitable cabling, the following characteristics should be considered:

1) Characteristic impedance matched to the termination impedance.

2) Low signal skew between differential pairs.

3) Low cross-talk between signal pairs.

4) Low EMI.

5) High noise immunity.

6) Low signal attenuation for long links.

Printed Circuit Boards

All RMLs will inevitably interface and propagate over printed circuit boards (PCBs). An RML may run its entire length over PCB in a backplane type environment. The signals are required to be routed using a constant distance separated pair of tracks with 100 Ω differential impedance.

Termination

The two pairs of differential channels in an RML are non-symmetric. The clock channel is unidirectional and is always generated by the RML master. The data channel is bi-directional and can be driven by the RML master and slave devices. Thus they have different termination requirements.

The clock channel is required to have a 100 Ωgt termination resistor across the differential pair at the RML slave and failsafe termination to assert a LVDS logic ‘1’ on the channel when the node is disconnected from the RML master. The data channel is required to have a 100 Ω termination resistor across the differential pair at the RML master and RML slave ends of the channel. Failsafe termination must be present at the RML master end of the link only.

Signal Level

The signaling level defined as part of this standard specifies the voltage levels, noise margins and data encoding. For signaling and noise margins, the RML uses the Low Voltage Differential Signaling (LVDS) and Bus LVDS (BLVDS) electrical standards as the signalling techniques for the communications links. The unidirectional clock channel uses LVDS signaling and the bidirectional data channel uses the higher drive current BLVDS specification.

LVDS defines a single electrical signal as the differential voltage between a pair of conductors. It uses a low voltage swing to implement a very high-speed switching speed with very low EMI. The differential nature of the signals greatly reduces the common-mode noise interference on the channel. Another benefit of the low voltage swing is low power consumption even at high speed. The LVDS standard specifies that at least +100 mV differential will be received as a logic ‘1’ and −100 mV differential will be received as a logic ‘0’.

Data Encoding

All communications over an RML in accordance with one embodiment of this invention are Double Data Rate (DDR) and synchronous to the RML clock. Data is latched into the receiver on the rising and falling edges of the clock (FIG. 3). Bits encoded on the rising or falling edge of the clock have the same meaning; no differentiation is made between them.

The reason for including a unidirectional clock line is so that the slave module need not generate its own clock. This allows all modules in the system to be synchronized to the RML master clock. It also reduces the cost of having to provide local clock generation components on every slave module.

In order to maximise the speed and reliability of the data channel, a pipelined transceiver is employed in present FPGA technologies to minimize the signal delays over the channel and achieve high data rates. This imposes a penalty on the link turn-around time as data is received up to two clock cycles after it is transmitted. Depending on the specific implementation, up to four dead cycles may be required to change the direction of the link.

The RML slave operates off the RML master clock and thus special attention must be paid to high speed communications. For high speed data rates (clock above 60 MHz), the slave device should use clock management functions to ensure that the slave transmitter clock has as close to zero skew to the received clock as possible. In an FPGA, a Digital Clock Manager (DCM) can be used. For long communications channels, the receiver clock must have the same phase as the received clock; however the transmitter clock may be advanced slightly ahead of the received clock to help reduce the clock-data skew and ensure the correct clock-data setup times at the master receiver. Over longer distances, a lower clock speed must be used, or extra link turnaround cycles may be inserted. The system designer must take into account the propagation delay of the cable and possibly reduce the data rate or increase the link turnaround dead cycles.

Character Layer

The RML protocol in accordance with one embodiment of this invention defines a number of Control, Data, Address and Escape Characters (FIGS. 5-8) which each comprise of a number of bits. A control character contains four bits and is used to control synchronization, initialization and acknowledgment of Data transfers. As shown in FIG. 5, a control character is formed from a control-flag, two control bits and a parity bit. The control-flag is set to zero to indicate that the character is a control character. The two control bits specify four possible control characters. The parity bit covers the three previous bits and is set to generate odd parity, so that the total number of 1's in the character is an odd number.

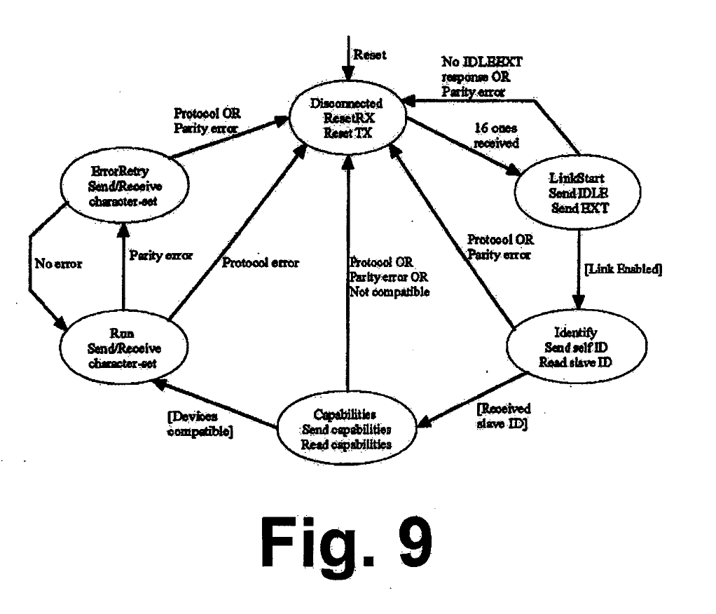

As shown in FIG. 7, data characters are ten bits long and contain a start bit, an eight-bit data value and a parity bit. The start bit is set to zero and data is formatted MSB to LSB. The parity bit is the odd parity of the character's first nine bits.

Address characters are ten bits long and are used for RML addressing. Address characters start with a start bit, a concatenation bit, seven address bits and a parity bit (FIG. 8). The start bit is always set to zero. The concatenation bit controls the joining of address characters to form an address and allows for address compression. The address bits are formatted MSB to LSB and the parity bit contains the odd parity of the character's previous nine bits.

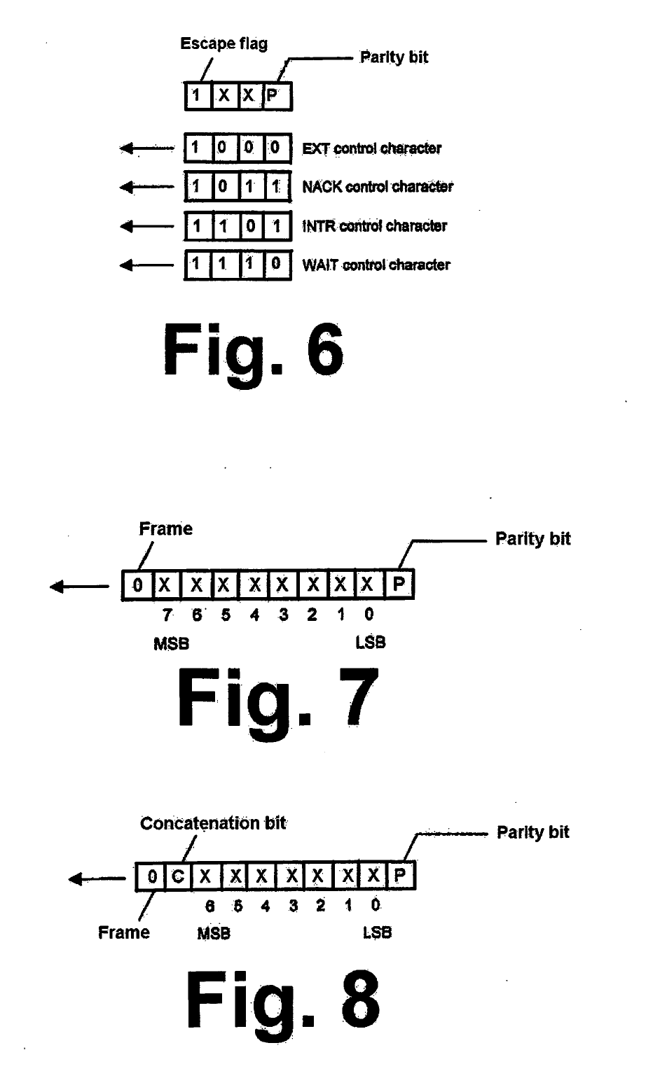

The Escape characters are similar to Control characters except that they start with an escape bit which is set to one and have a two bit escape code and an odd parity bit (FIG. 6).

When the link is active, each end of the link, the master and slave, continually exchange character sequences. A transmitter transmits one or more characters that form a character-set before control is given to the other side of the link. The character-set always starts with a Control or Escape character and may contain zero or more DATA and ADDRESS characters. The characters in the character-set follow directly after each other with no NULL cycles between them.

During communications, it is necessary to change the link direction after the transmission of each character-set. Depending on the link speed and communications transceivers, a number of NULL cycles are inserted to allow transmitter and receiver pipelines to clear. The amount of NULL cycles implemented must be identical in the master and slave devices. It is also possible to design master and slave devices that can automatically detect and adjust for differing link lengths by automatically attempting communication with different numbers of NULL cycles.

Exchange Layer

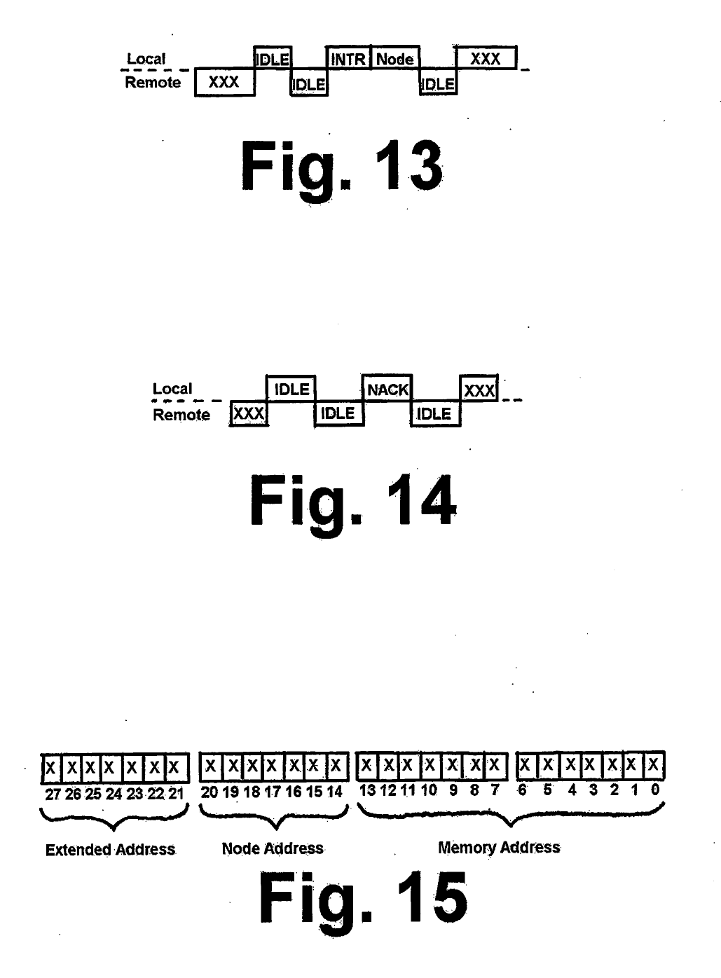

The exchange layer protocol provides services for RML link management in the form of a state machine (FIGS. 9-14). The services are described below:

Initialization:

After a reset (FIG. 9), the link is not driven by either the RML master or slave. The failsafe termination will assert a logic ‘1’ on the line until the RML master is instructed to initialize the link. The link is established by a handshake protocol that ensures both ends of the line are ready for communications. The master samples the line until 32 consecutive ones are detected. This confirms that the slave is not trying to transmit on the line. The slave samples the line until 16 ones are detected. It then awaits an IDLE character which the master transmits as the slave is waiting. The slave responds by sending an IDLE control character back. The master then sends an EXT character to which the slave responds with an EXT character. This verifies that the slave device is present and is in the correct state, ready for identification.

Identification (Optional):

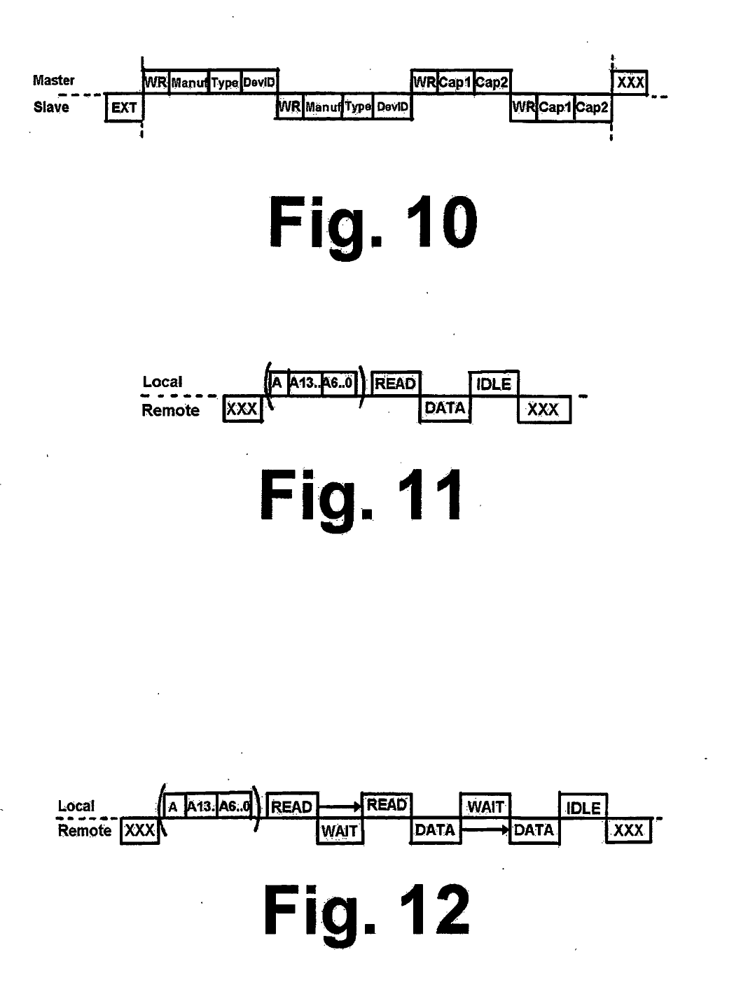

After the link initialization, the master queries the slave identification and identifies itself to the slave (FIG. 10). Following the receipt of the EXT character in the link initialization, the master issues a READ control character. The slave then responds with its RML ID, a 24-bit value packaged in three DATA characters. The master then issues a WRITE to the slave and sends its 24-bit RML ID to the slave. After exchanging identification data, the slave issues a WRITE to the master and sends an eight-bit CAPABILITY value to the master in one DATA character. The master then responds by sending its CAPABILITY value to the slave in the same manner. The master and slave compute whether they are able to communicate using the CAPABILITY data they received and if so, respond by exchanging IDLE characters.

Disconnect Detection:

Link disconnection is detected by the RML master or slave when 16 or more consecutive one-bits are detected on the data channel i.e. no information is travelling across the link. The slave can also detect a link error by the loss of the clock channel from the master. When a disconnect is detected, the link attempts to recover from the error with the master starting the initialization procedure.

Parity/Frame Error Detection:

Parity errors can occur in any character transmitted over the link. They are detected before the transmission of the first character in a new character-set. Frame errors occur on DATA and ADDRESS characters where the first bit of the character is not zero. If a parity or frame error is detected, the link attempts to recover from the error.

Parity/Frame Recovery:

Following a frame or parity error, the link first attempts to recover from the error gracefully. If an error is detected during a character-set, the receiver continues to receive the character-set according to protocol specification but does not pass it onto higher level protocols. At the end of the character-set, the link direction is reversed and the end that received the error responds with a single NACK character. The link direction is reversed again and the original transmitter attempts to resend the character-set to which the receiver had replied with the NACK. If no errors occur during the retransmission, the communications continues as normal. If a second error occurs during the re-transmission, the receiver responds to the character-set with a second NACK character. Both master and slave devices will release control of the link. The master then samples the line until 32 consecutive ones are detected on the channel. The initialization protocol is then carried out. If the master and slave detect a different partner at the other end of the line, then the devices signal a bus reconfiguration event to the rest of the system.

Link Error Recovery:

Link error recovery is the same as parity/frame error recovery except that the state where the master and slave release control of the link is entered immediately. If the slave enters this state due to a loss of clock channel, the master will detect a disconnect error and attempt to recover the link.

Packet Layer

The packet layer protocol defines how data is transmitted and requested over the RML link by packets created by a sequence of character-sets each containing ADDRESS, DATA, CONTROL and ESCAPE characters.

The RML link's primary use is to export a bi-directional, parallel data bus across a serial communications channel. Secondary services that are provided by the link are bi-directional interrupt support and node identification and enumeration. The link also reserves unused packet encodings for future feature extensions of the protocol.

Packets

Packets consist of a number of character-sets, each containing one or more character-sequences, with one or more characters. The two packet types are the Transaction and Control Packets. Three transaction packets are defined:

Address preload packets: set the receiver address register.

Read packets: read data from the receiver with optional address.

Write packets: write data to the receiver with optional address.

Two control packets are defined: Idle packets and Interrupt packets. A read or write packet may contain one or zero address sequences and a read or write (or extended write) data sequence. After each packet, the direction of the link is reversed to allow the fair sharing of the link bandwidth (multiple access). If the device with current control of the link has nothing to transmit or request, an idle packet is transmitted and the direction (or control) is changed again. During certain packet types, such as read packets, the direction of the link may be changed; however before the packet is completed, control must be released back to the device that initiated the packet in order for the packet to be completed.

Each standard read or write sequence transmits N*8-bit bytes only which is defined in the CAPABILITY field which is equivalent to the bus width (or word size) of the link. An extended write sequence allows up to 128 bytes to be transmitted across the link to support burst writes or DMA with less protocol overhead.

Every packet includes an acknowledgment which in the common case of no errors being present, is an implicit acknowledge. The start of a packet can be any control or escape character (unless it is undefined for the present state) other than the NACK character. When an error is detected, the NACK character is used to indicate that an error was detected. Any other character which starts a new packet is an implicit acknowledgment of the previous packet.

Addressing

The RML standard allows a network of modules to be connected to a single virtual parallel bus with global addressing. RML defines an addressing standard for the network which defines two address types for RML links. All modules in a system implementing RML (RML network) have a unique address range to which they respond. The address space is split into two ranges for the two RML address types, global addresses and local addresses. These addresses are allocated as follows. The global address space is 28-bits (256 MB) with room for future expansion. An RML address contains a 14-bit memory address, 7-bit node address and 7 bit extended address (FIG. 15).

Local addresses correspond to the device connected to the same physical bus as the node generating the address. An address with the node address set to zero is a local address. Over an RML channel, a local address addresses the remote module only.

Global addresses can address any device on any module in the RML network. An address with a node address other than zero is a global address. The node bits in the address can specify the node and bridge depth from the RML master. The Ext bits are used to address larger memory regions (in 16 kb blocks) in the addressed node.

Master→7 first nodes→6 second nodes→3 third nodes=112 nodes (FIG. 16)

Decoding

CCBBAAAb

When AAA is zero, this denotes a special address:

0000000b—This is the local node address

0001000b—This is the RML network master node address

1111000b—This is the broadcast address

When AAA is non-zero, a slave node is addressed.

When CC and BB are zero, a first level slave node is addressed. 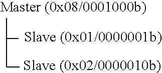
When CC is zero and BB non-zero, a second level slave node is addressed with its parent node having the same BBB bits. 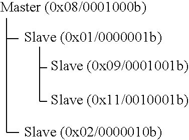
When BB is zero and CC non-zero, a second level slave node with no children is addressed. 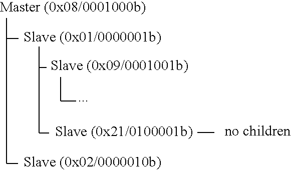
When BB and CC are both non-zero, a third level slave node is addressed with its parent being the node with the same address excepting with the CC bits zero.

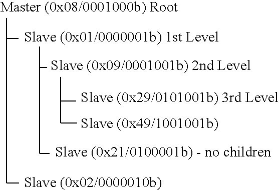

Network Layer

The network layer defines an RML network, describes how nodes are linked to form the network, defines how transactions take place across the network, defines how errors are handled and how the network is probed and configured.

An RML network is made up of a number of RML nodes connected in a tree hierarchy. The root of the tree is the RML master controller and it is responsible for network configuration and management. All nodes in the network have equal share of bandwidth and may generate and receive bus requests.

Each node may have a single RML slave interface and multiple RML master interfaces, unless clock domain bridging is provided in which case, only a single RML slave per clock domain is allowed per node. The node providing the synchronisation clock may not have a slave interface in the same clock domain.

The RML network master-slave configuration is not related to the RML link master-slave configuration which is primarily used for link initialisation and clock distribution. Although the RML link clock is a fixed frequency, the entire RML network need not operate off the same clock.

In summary, the RML of this invention provides a multiple access, synchronous communications channel with explicit master-slave clock distribution. RMLs are transparent to bus master and slave devices in all RML nodes, allowing these devices to have simple implementation. RMLs are transparent, allowing devices on a single node to be exported to another device without any modification to the function. RMLs are transparent, requiring no software or state machine intervention for inter-node communications. RMLs are bit synchronous, which allows DDR implementation. RMLs provide bi-directional interrupt support for flexible device implementation and reduced bus traffic by allowing polled actions to be interrupt based. RMLs use address based routing, which allows simple system design and device design. RMLs use a separate clock and data signal so that it can be implemented in simple FPGA based logic devices without clock recovery circuits. RMLs allow for link length extension with the provision to insert multiple NULL cycles during direction changes as well as allowing clock management for timing correction. RMLs are protocol synchronous so that link errors are immediately identified and action can be taken, as well as ensuring data integrity. RMLs provide automatic bit error recovery and link error recovery for simpler system implementation. RMLs allow for “hot” plug and disconnect of nodes with automatic network reconfiguration for dynamic networks to be created. RMLs operate using two signal communications (clock and data) so that minimal node interconnect is required. And, finally, RML supports bus master devices as a superset of DMA.

It will, of course, be understood that various modifications and additions can be made to the preferred embodiments discussed hereinabove without departing from the scope of the present invention. Accordingly, the scope of the present invention should not be limited by the particular embodiments described above, but should be defined only by the claims set forth and equivalents thereof

1. A communications apparatus comprising:
a bidirectional, fair multiple-access, synchronous serial communications protocol operational with a single clock and a single data signal, said single clock adapted to provide a unidirectional clock signal to synchronize a remote end of said apparatus with said single clock.

2. A communications apparatus in accordance with claim 1 further comprising at least one field programmable gate array (FPGA).

3. A communications apparatus in accordance with claim 1, wherein said protocol is command-based with implicit data acknowledgment.

4. A communications apparatus in accordance with claim 3, wherein said protocol comprises automatic error detection and retry means.

5. A communications apparatus in accordance with claim 4, wherein said protocol comprises link communication monitoring and interrupt transport support means.
